(19) United States
(12) Patent Application Publication
(10) Pub. No.: US 2009/0072055 A1
(43) Pub. Date: Mar. 19, 2009

(54) Shaker dispensing container

(75) Inventors: Laura Flanagan-Kent, Decatur, GA (US); Gary L. Mengeu, Wheeling, WV (US); Bryan P. Haring, Snellville, GA (US)

Correspondence Address: FOLEY & LARDNER LLP, 777 EAST WISCONSIN AVENUE, MILWAUKEE, WI, 53202-5306, US

(73) Assignee: Silgan Plastics Corporation

(21) Appl. No.: 12/078,203

(22) Filed: Mar. 28, 2008

Related U.S. Application Data
(63) Continuation-in-part of application No. 29/287,774, filed on Sep. 19, 2007, now Pat. No. D570222.

(51) Int. Cl. A01C 15/00; A01C 15/02; B67D 3/00

(52) U.S. Cl. 239/664; 239/652; 222/533

(57) ABSTRACT

A manually operable spreader for particulate material has a container body, a generally U-shaped chute and a cap sealing a discharge aperture. The body has a hand grip and the chute has one end pivotably mounted on the body. The sidewalls of the chute seat in recesses in the sidewalls of the body. When the chute is in its operative position, the contents flow onto the chute and then onto the ground.

### BACKGROUND OF THE INVENTION

The present invention relates to containers for spreading particulate materials.

There are numerous types of particulate materials which are intended to be spread over finite areas such as seed, fertilizers, herbicides and the like. Larger volumes of materials and/or areas to be treated generally utilize mechanical spreaders into the hopper of which the material is filled, the mechanical spread can be one in which the material flows from the hopper and through a discharge opening. Some mechanical devices have a rotating element which spreads the material over a wider path.

To minimize contact with the particulate material, some manufactures provide containers which have dispensing openings through which the material is discharged, and the user may move the container in an accurate path or shake the container as the material is flowing therethrough.

It is all object of the present invention to provide a novel dispensing container for spreading particulate materials.

It is also an object to provide such a container with a spout which facilitates spreading of the discharged materials.

Another object is to provide such a container which is easy to use and relatively economical to manufacture from parts which may be readily assembled.

### SUMMARY OF THE INVENTION

It has now been found that the forgoing and related objects may be readily attained in a manually operated spreader for particulate materials which includes a container body with side walls, a top wall, a bottom wall and end walls. The body provides a hand grip and has a discharge opening in one end wall thereof.

A generally U-shaped chute has spaced side walls and a transverse wall extending therebetween. The chute has a first end portion pivotably mounted on the body and extensible over the discharge opening. The chute is pivotable from a storage position in which the side walls extend from one end of the body and along the sides of said body, to an operative position in which the chute projects from the one end of the body and below the discharge opening. A cap is releasably engaged on the body and seals the discharge opening.

Preferably, the body member hand grip is provided by an elongated aperture extending through and bounded by the material of the side walls. The aperture is elongated and disposed adjacent the top wall to provide a bridge of reduced width which can be easily gripped by the user.

Conveniently, the side walls of the body have a recessed surface portion adjacent the one end. The side walls of the chute seat in the recessed surface portions of the side walls in the storage position.

Desirably, one end of the chute has projecting portions on the side walls, and the projecting portions have generally circular bosses thereon seating in circular recesses in the side walls of the body to provide a pivotable mounting therefor.

The side walls of the chute have circular bosses on their inner surface, and the side walls of the body have circular recesses in which the bosses releasably seat to maintain the chute in the inoperative position. Preferably, the transverse wall of the chute has a multiplicity of upstanding ribs providing channels therebetween.

The cap may have a transverse wall with at least one aperture extending therethrough and a cover removably seated over the aperture.

The cover of the cap is divided into two pivotable doors providing openings of different size to control the rate of flow of particulate from the body.

### BRIEF DESCRIPTION OF THE DRAWINGS

FIG. 1 is a perspective new of a shaker embodying the present invention and with the chute in its closed or inoperative position;

FIG. 2 is a side elevational view thereof;

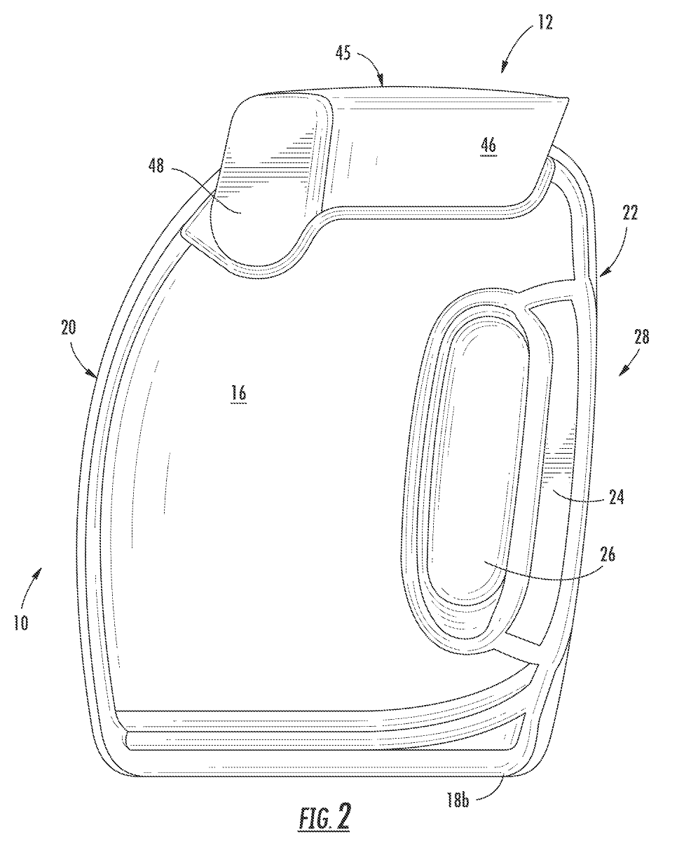

FIG. 3 is a perspective view with the chute or spout in its operative position and the cap partially opened;

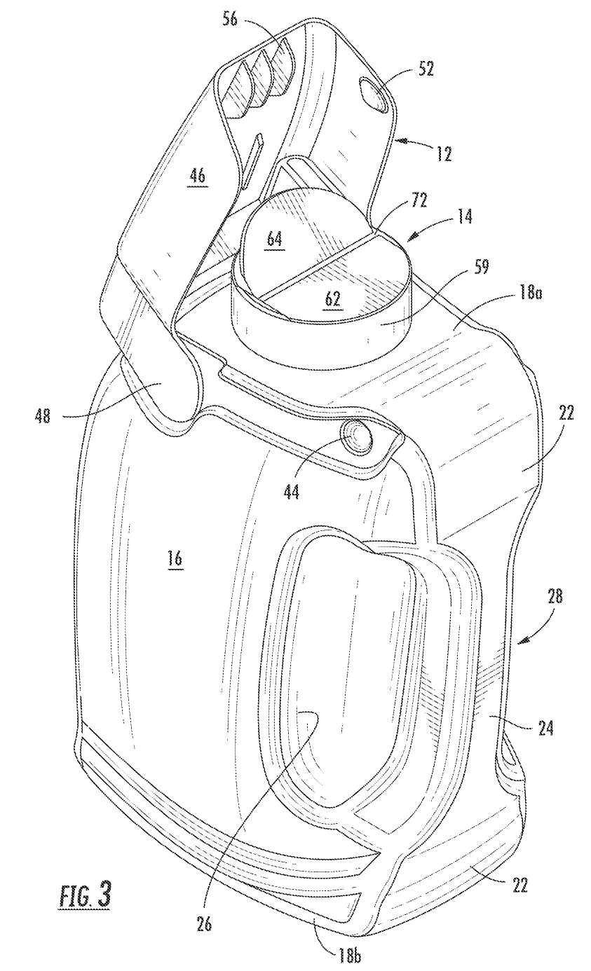

FIG. 4 is a top view thereof with the chute in its inoperative position;

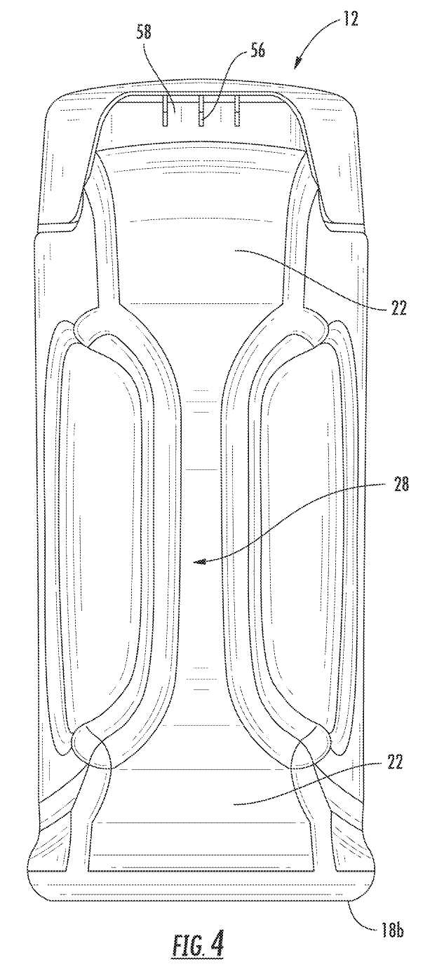

FIG. 5 is a bottom view thereof;

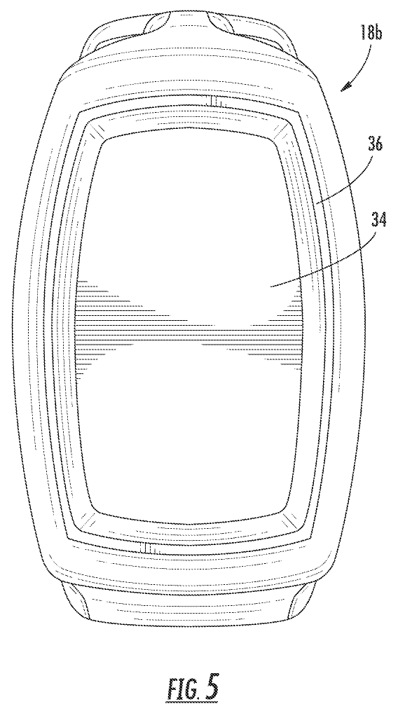

FIG. 6 is a perspective view of the chute; and

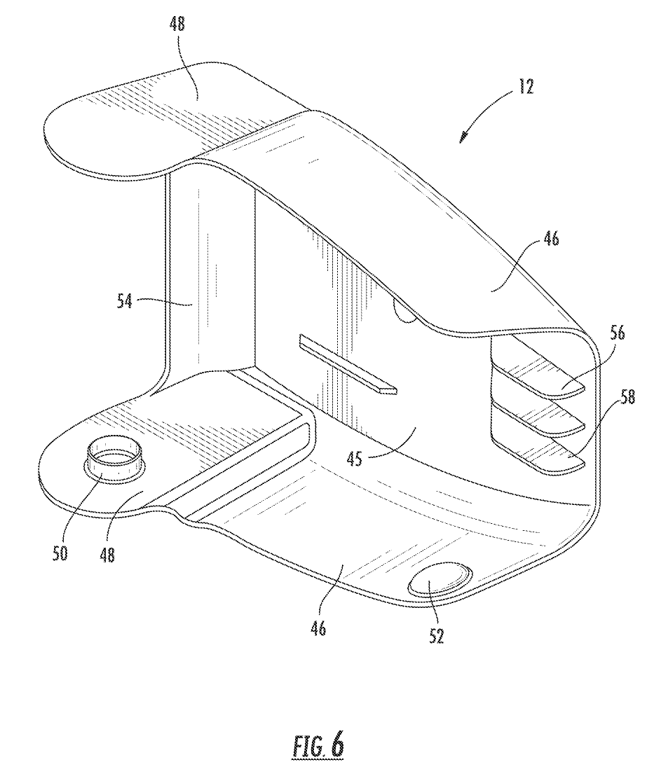

FIG. 7 is a top plan view thereof.

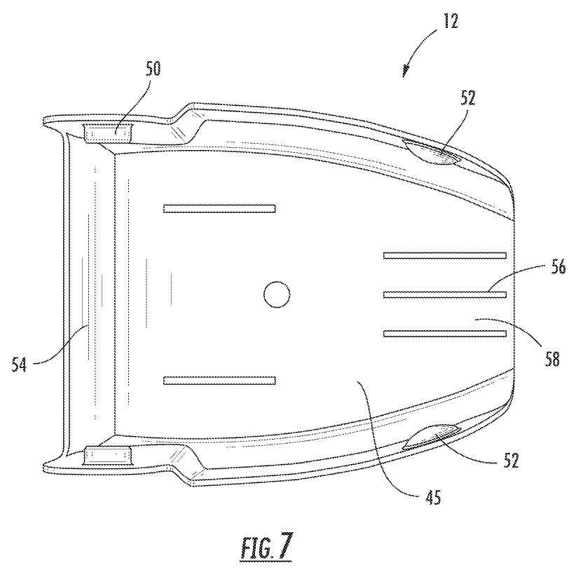

### DETAILED DESCRIPTION OF THE ILLUSTRATED EMBODIMENT

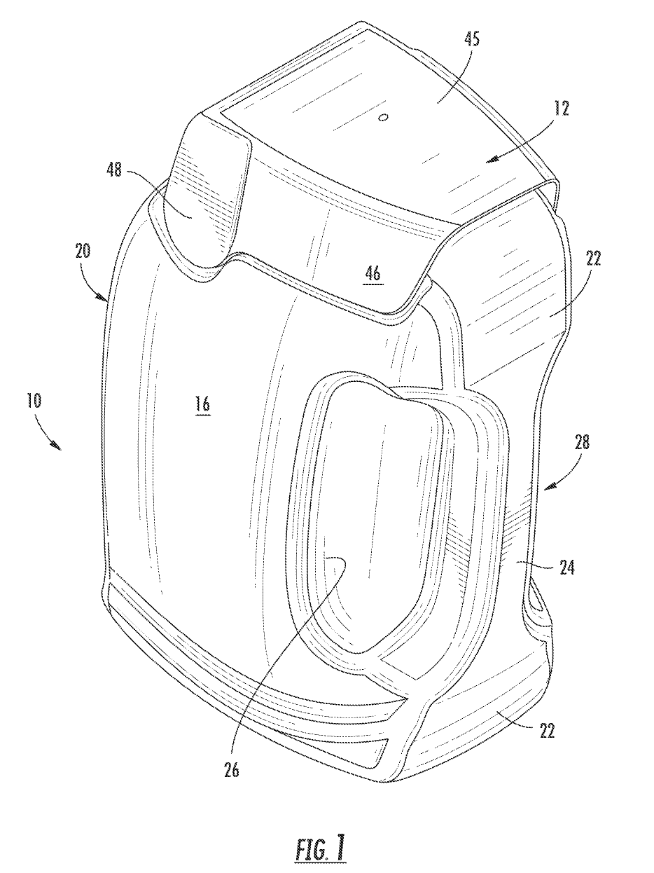

Turning first to FIG. 1, therein illustrated is a spreader embodying the present invention and comprising a molded container or body generally designated by the numeral 10, and a chute generally designated by the numeral 12 pivotally mounted on the body 10 at one end thereof, and a cap generally designated by the number 14.

The container 10 is integrally molded and has a pair of side walls 16, a pair of end walls 18, a bottom wall 20, and a top wall 22. The top wall 22 has an intermediate portion 24 which is of reduced width and an elongated aperture 26 in the side walls 16 cooperate to provide a bridge 28 which is gripped by the user. The front end wall 18a has a dispensing opening 30 with a threaded collar 32 thereabout. The rear end wall 8b has a generally planar portion 34 and a peripheral boss 36 providing a stable seating surface. The side walls 16 have recesses 38 at the puncture of the side walls 16 and front end wall 18a. Shallow recesses 40 extend from the upper end of the recesses 38 to the top wall 22.

In the recesses 40 are cylindrical recesses or indents 42, and adjacent the upper end of the recesses 38 are spheroidal recesses or indents 44.

The chute 12 has a bottom wall 45 with a pair of side walls 46 with upstanding portions 48 at the front end wall 8a and 48 and on which are provided generally cylindrical bosses 50 which seat in the indents 42 to provide a pivotable connection therefor. At the opposite end of the chute 12 are spheroidal bosses 52 which snap into the spheroidal indents 44. At the inner end of the side walls is a 12 is a transverse wall 54 of limited height. Adjacent the front end of the chute 13 are a multiplicity of upstanding ribs 56 which provide channels 58 therebetween.

Turning lastly to the cap 14, it is integrally molded with a peripheral wall or skirt 59 having threads 60 which thereby engage with the collar 32. The top or transverse wall is comprised of a fixed segment 62 and a hinged segment 64. The segment 64 is pivotably connected to the transverse strap or bridge 72.

In use, the cap is removed or a fitment is opened for material to flow outwardly of the spout and onto the chute. Clumping is reduced by the ribs on the chute as the material moves towards the end of the chute. When the desired area has been treated, the cap may be replaced or closed. Typically, the product can be small or large granular pellets used to cover an area for treatment by dispensing materials ant deterrent, lawn care treatment, fertilizer or any application requiring a dry granular area treatment.

The cap can have fitments which can be used to control the rate of discharge of the particulate material therethrough, or the cap can be removed in its entirety with the rate of discharge being variable by the angle of the container relative to the horizontal.

The container of the present invention is easy and economical to fabricate since only three parts are involved. The chute positioning in operative or inoperative positions is accomplished by engaging the bosses on the chute into recesses formed in the container. The chute is readily secured in the inoperative position with the side walls of the chute seating in the recessed surface portions in the side walls of the container.

Thus, it can be seen from the foregoing detailed specification and attached drawings that the container of the present invention may be readily fabricated to spread particulate material in the path of movement of the arm of the user to cover an area.

Having thus described the invention, what is claimed is:

1. A manually operated spreader for particulate materials comprising:
(a) a container body having side walls, a top wall, a bottom wall and end walls, said body providing a hand grip and having a discharge opening in one end wall thereof;
(b) a generally U-shaped chute having spaced side walls and a transverse wall extending therebetween, said chute having a first end portion pivotably mounted on said body and extensible over said discharge opening, said chute being pivotable from a storage position in which the side walls extend from said one end of said body along the sides of said body, to an operative position where said chute projects from said one end of said body below said discharge opening; and
(c) a cap releasably engaged on said body and sealing said discharge opening.

2. The manually operated spreader in accordance with claim 1 wherein said body member hand grip is provided by an elongated aperture extending through and bounded by the material of said side walls.

3. The manually operated spreader in accordance with claim 2 wherein said aperture is elongated and disposed adjacent the top wall to provide a bridge of reduced width.

4. The manually operated spreader in accordance with claim 1 wherein said side walls of said body have recessed surfaces therein adjacent said one end.

5. The manually operated spreader in accordance with claim 4 wherein said side walls of said chute seat in said recessed surfaces of said side walls in said storage position.

6. The manually operated spreader in accordance with claim 1 wherein said one end of said chute has projecting portions on said side walls, said projecting portions having generally circular bosses thereon seating in circular recesses in said side walls of said body to provide the pivotable mounting therefor.

7. The manually operated spreader in accordance with claim 1 wherein said side walls of said chute have circular bosses on their inner surface, and said side walls of said body have circular recesses in which said bosses seat to maintain said chute in the inoperative position.

8. The manually operated spreader in accordance with claim 1 wherein said transverse wall of said chute has a multiplicity of upstanding ribs providing channels therebetween.

9. The manually operated spreader in accordance with claim 1, wherein said cap has a transverse wall with at least one aperture extending therethrough and a cover removably seated over said at least one aperture.

10. The manually operated spreader in accordance with claim 1 wherein said cover of said cap is divided into two pivotable doors providing openings of different size to control the rate of flow of particulate from the body.
